(19) United States
(12) Patent Application Publication
(10) Pub. No.: US 2015/0135658 A1
(43) Pub. Date: May 21, 2015

(54) LID FOR LEAF COLLECTION WITH A BLOWER/VACUUM AND THE DISCHARGE OF DEBRIS INTO A BAG

(71) Applicants: William Laliberté, Quebec (CA); Denis Laliberté, Quebec (CA)

(72) Inventors: William Laliberté, Quebec (CA); Denis Laliberté, Quebec (CA)

(21) Appl. No.: 14/476,681

(22) Filed: Sep. 3, 2014

(30) Foreign Application Priority Data
Nov. 18, 2013 (CA) 2833062

(51) Int. Cl. B01D 46/00; B01D 46/42; A47L 9/24; A47L 9/12; A01G 1/12; A47L 5/14

(52) U.S. Cl. CPC B01D 46/0004; A01G 1/125; A47L 5/14; A47L 9/242; A47L 9/248; A47L 9/122; B01D 46/002; B01D 46/4227
USPC 55/357

(57) ABSTRACT

A lid for leaf collection with a blower/vacuum and the discharge of debris into a bag is described. The lid is round shaped with a curved edge and has a partially round opening for the entry of debris and air and has two square openings with a domed top and back for air outlet. An elbow is inserted into the opening for the entry of debris for receiving and directing debris and air coming from the blower/vacuum to the side wall of the lid. From there, the debris is diverted into a bag held around the lid with an elastic cord. The square openings for the air outlet are large and enable the rapid exit of air introduced while retaining the debris using two strainers. The elbow and the lid are connected to the blower/vacuum by two ribbed connecting pipes.

### TECHNICAL FIELD

The present invention relates to a lid for collecting leaves with a blower/vacuum and the discharge of debris into a bag. The lid is round-shaped with a curved edge and has a partially round opening for the entry of debris and air and two square openings with a domed top and back for air outlet. An elbow is inserted into the opening for the entry of debris to receive and direct debris and air coming from the blower/vacuum.

### BACKGROUND OF THE INVENTION

The blower/vacuums are well known as lawn and garden implements which are used for blowing or picking up various debris, such as leaves and grass clippings. A typical blower/vacuum in suction mode comprises a housing that encloses an electric motor having a rotatable shaft on which is connected a fan placed in a housing. During the rotation of the motor, the fan mounted on the shaft rotates and creates a suction which draws the leaves and other lawn debris into the fan inlet where they are shredded and then ejected from the fan outlet. A handle is provided on the housing to allow the operator to hold and direct the inlet of the blower/vacuum. In the mode normally used, the blower/vacuum discharges debris into a small collection bag coupled directly to the fan outlet of the blower/vacuum. The operator wears the debris collection bag on his shoulder with a belt attached to the bag. The weight of the debris that accumulates in the bag tires out the operator in time. When the collection bag is full, the operator disconnects the collection bag from the fan outlet of the blower/vacuum, unzips a zipper provided in the bag, and then dumps the debris out of the bags into a larger disposable bag to collect debris, a trash can or a place for decomposing debris. The operator can then close the collection bag with the zipper, connect it to the blower/vacuum and continue to collect debris. This type of debris collection bag, although effective for collecting small amounts of debris, quickly becomes limiting for the collection of large amounts of debris. It must frequently be emptied which becomes tedious and slows significantly the work of the operator. In addition to the weight of the bag and debris, the bag being suspended from the operator's body, the dust emitted by the air output through the bag pores can be annoying to operators.

Other debris collection systems were invented to correct problems of the conventional system described above. U.S. Pat. No. 7,506,403 B2 has a collection bag in a cart with wheels, the bag must be emptied when full and the system is designed for one type of bag. The operator also has the disadvantage of pulling a wheeled wagon with the bag of debris. U.S. Pat. No. 7,587,785 B2, the operator wears the receptacle on his back to collect the debris and debris must be emptied into a bag for disposal. For the U.S. Pat. No. 6,988,293 B2, leaves are collected directly into a bag with slots to the air outlet, the bag is disposable which eliminates the need to pour the debris and the bag is designed specifically for the system. The bag is attached to the blower/vacuum and the weight of the bag and debris is carried by the operator. It is not possible to use a wide variety of bags to collect debris which limits the choice of supplier. The bag is of small dimensions compared to the collection bag for lawn debris. For U.S. Pat. Nos. 7,962,996 B1, U.S. 7,917,992 B2 and U.S. 7,752,706 B2, the debris is collected in a large collection bag inserted into a large solid container mounted on a cart. The cart can be moved and carries the weight of debris. This system is relatively heavy and large. It can be cumbersome to move over rough terrain. The operator must move the cart as the work progresses. In U.S. Pat. No. 8,091,815 B2, blower/vacuum and leaf debris are transported in a wheelbarrow or a big truck while for U.S. Pat. No. 8,100,416 B1, it is transported in a small two-wheeled cart. For the latter, the debris is collected in a small bag. These two patents have the same shortcomings as the aforementioned patents. For U.S. Pat. Nos. 7,257,858 B2, U.S. 6,574,829 B1 and U.S. 4,713,858, the debris collection system is maintained by a support frame made of metal or a metal container. Debris is collected into a large bag. These systems are fixed and the leaves must be near the system to be collected. The operator cannot easily move the system in use. For U.S. Pat. Nos. 7,341,612 B2, U.S. 7,185,389 B2 and U.S. 4,723,971, the debris is sucked into a small bag or into a rigid container without being shredded first, requiring much more space for storage. In addition, the materials must be small like dust or sawdust, and it is not suitable for collection of whole leaves. The system moves on casters or wheels which can pose a problem when the ground is uneven. A single bag model can be used.

Accordingly, it is necessary in the art of collecting debris to have a debris collection system allowing both the mobility of the operator and the collection of large amounts of debris without having to pour debris in another bag and without requiring the operator to carry the bag of debris. Similarly, it is also necessary to have a versatile system that can use a wide variety of bags sold by different companies for the collection of debris to reduce the cost of buying bags and therefore storage costs of debris.

In the art of debris collection, the debris is usually kept in bags placed in metal containers or plastic which is covered with a lid to prevent odors and to protect them from weather. These lids are often round in shape and slightly curved. These lids are designed to be watertight and airtight for the uses for which they are intended. One of these types of lid has a groove on the side wall. U.S. Pat. No. 4,691,840, U.S. 5,163,577, U.S. 5,085,340, U.S. 5,160,060, U.S. Des. 326,342 and CA 2542229 refer to this type of lid. This type of lid does not have any openings in the top, which takes away the possibility of inserting debris into containers or bags inside the containers without having to remove the container lid.

Accordingly, as this type of lid, round in shape and having a groove on the side wall, with openings for the air outlet and openings for the discharge of lawn debris directly into a collection bag using a blower/vacuum in suction mode, did not exist, Laliberté, W. and D. Laliberté, 2011, in the patent CA 2,748,583, have invented a type of lid adapted to this need. They also presented the possible modifications to existing lids using their invention to allow their use with the collection system described in their patent application.

The type of lid stated in the patent CA 2,748,583 from Laliberté, W. and D. Laliberté, 2011, with a groove on the side to hold the bag up around the lid with an elastic cord, although very effective, the application technique molding plastics is more expensive than the manufacturing technical plastic injection. Indeed, the presence of the groove on the side does not allow the use of the technique of injection molding, which is better suited for producing large quantities with the lowest costs per lid.

This is in order to reduce production costs inherent in this type of lid that a new type of lid without a groove, but with a curved edge to the outside, was designed to be manufactured by plastic injection molding. This type of lid is described in patent CA 2,764,509 from Laliberté, W. and D. Laliberté, 2012 and CA 2,780,100 from Laliberté, W. and D. Laliberté, 2012.

In the patent application CA 2,790,305 from Laliberté, W. and D. Laliberté, 2012, have made changes on the method of attachment of the ribbed connecting pipe to the lid, making a handle with a plastic cable tie, the method of attachment of the elbow for the entry of debris into the lid, the method of attachment of the ribbed connecting pipe to the blower/vacuum with a plastic coupling sleeve and installation of a piece of thick plastic or metal attached on top of the lid and of which a part is placed below the membrane near the lid.

In patent applications CA 2,809,923, Laliberté, W. and D. Laliberté, 2013 made changes on the ribbed connecting pipe and the method of attachment to the blower/vacuum.

Patents or patent applications from Laliberté, W. and D. Laliberté, 2013 mentioned above relate to lids with two circular or rectangular openings to air outlet and an opening for the entry of debris with two 45 degree elbows or a 90 degree elbow inserted (s) in this opening.

The present invention relates to the manufacture of a lid with two air outlet openings with a square base and with a domed top and back and an opening for the entry of debris with an elbow whose angle is between 75 and 100 degrees. The two ends of the elbow are preferably the same diameter. It is also understood that the two ends of the elbow can have different diameter.

The construction of two square openings in the base allows for a larger surface for the exit of the air and reduces the air pressure within the debris collection bag. It follows that it takes less strength to hold the bag around the lid, which requires an elastic cord that is weaker and also less expensive to hold the bag.

The use of an elbow whose angle is between 75 and 100 degrees is to allow greater flexibility in the choice of the optimum angle for the entry of debris. Also, the construction of an elbow having the same diameter at both ends is simpler than when both ends of the elbow are of different diameters.

### SUMMARY OF THE INVENTION

The lid is round in shape, with a flat or slightly domed top with a curved U-shaped edge made by the lateral side of the lid and the curvature of the extension of the wall folded towards the outside of the lid. The lid has on top a first and a second opening for the air outlet whose base is square and the top and back are domed and a third opening for the entry of debris which is partially round with a flared U-shape extension. An elbow whose angle is between 75 and 100 degrees is inserted into the third opening to allow entry of debris and direct debris. Two holes are located near the third opening to attach the second end with a hole of the elbow on the inside of the lid. Two holes on the lid are located between the two openings for air outlet, these holes allow one to make a handle with a plastic cable tie. The lid has on the inner face hook-shaped attachments for holding the first and the second strainer. Elevations are located on the side wall near the lower limit of the flange to retain an elastic cord.

The main advantage of this system for collecting leaves is that it allows for faster collection of leaves by using a larger bag, and debris is stored directly into the debris collection bag. It is no longer necessary to pour debris from one bag to another. It is also easier to use, since it is not necessary to transport debris in a bag on the shoulder or a cart. It also allows for greater mobility in the field. It also increases the performance of the blower/vacuum by reducing the loss of suction caused by the resistance of the air passing through the pores of the cloth bags usually used.

### BRIEF DESCRIPTION OF THE DRAWINGS

This invention will be described in more detail in the following description taken in conjunction with the following drawings, wherein like reference numbers indicate like elements throughout.

FIG. 1 is a side perspective view of the top and the outer lateral side of the lid with a curved edge and openings for air outlet.

FIG. 2 is an underside perspective view of the inside face of the lid with a curved edge and openings for air outlet.

FIG. 3 is an underside perspective view of the inside face of the lid with a curved edge and openings for air outlet with the strainers for air filtration.

FIG. 4 is a front perspective view of the top and the outer lateral side of the lid with a curved edge and openings for air outlet.

FIG. 5 is a side perspective view of the top and the outer lateral side of the lid with a curved edge and openings for air outlet.

FIG. 6 is a back perspective view of the top of the outer lateral side of the lid with a curved edge and openings for air outlet.

FIG. 7 is a perspective view of the front and the side of the elbow.

FIG. 8 is a perspective view of the lid with a curved edge and openings for air outlet when inserted into a debris collection system.

### DETAILED DESCRIPTION OF THE PREFERRED EMBODIMENT

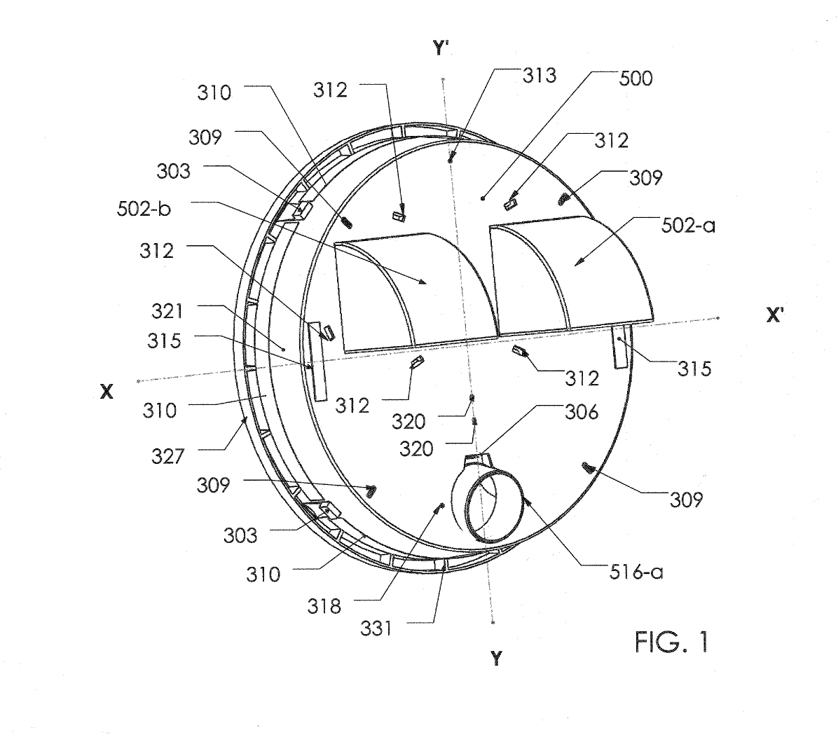

FIG. 1 is a side perspective view of the top and the outer lateral side of the lid 500 with a curved edge and two openings 502-a and 502-b for air outlet of which the base is square and the top and back are domed. Both openings are on the top of the lid and the front of the openings is near the axis XX′. The first and second opening 502-a and 502-b are an integral part of the lid and are molded at the same time as the lid 500. Openings 502-a and 502-b for the air outlet are on either side of the axis YY′ in quadrants X′Y′ or XY′ respectively and the front openings are oriented toward the axis XX′. It is also understood that the front of the openings may be oriented at different angles relative to the axis XX′ and YY′. The front openings for the air outlet are oriented so as to direct air toward the floor. The center of each openings 502-a and 502-b for the air outlet is preferably located at the same distance from the axis XX′. The center of each opening 502-a and 502-b for the air outlet is preferably also located at the same distance from the axis YY′, the center of each opening 502-a and 502-b for the air outlet being not at the same distance from the axes XX′ and YY′. It is also understood that the center of each of the openings may be at different distances from the axes XX′ and YY′.

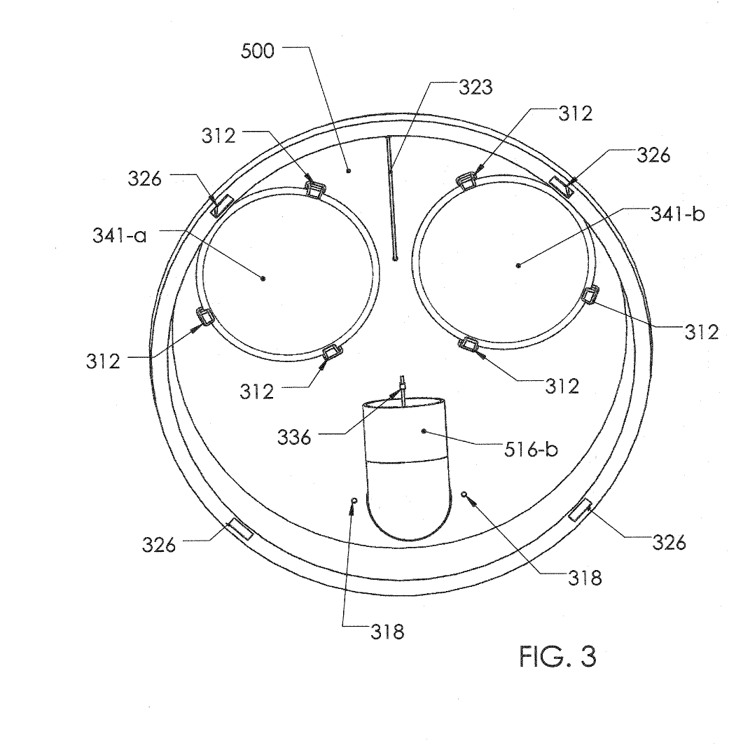

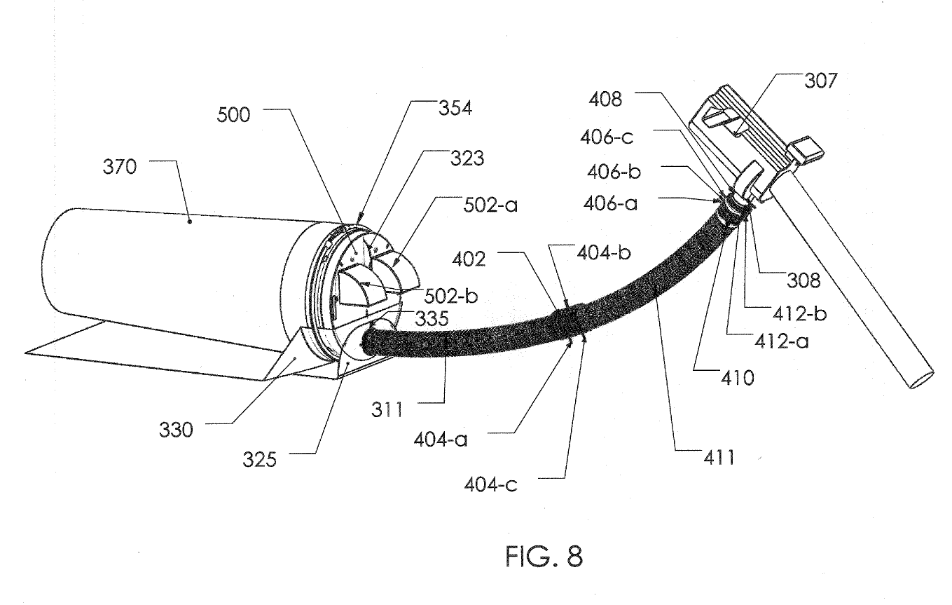

Around each of the openings 502-a and 502-b for the air outlet are preferably arranged three elevations 312 shaped like a hook for holding the first and second strainers 341-a and 341-b (FIG. 3). The elevations 312 are arranged in an isosceles triangle in the preferred form, but it is understood that they can also be arranged according to different forms. It is also understood that the number of elevations 312 shaped like a hook can be larger than three to hold each of the strainers 341-a and 341-b (FIG. 3). Without being limiting, the number of hook-shaped elevations 312 can also be four to hold each one of sieves. The strainers 341-a and 341-b (FIG. 3) filter the air exiting from the lid through the openings 502-a and 502-b for the air outlet and keep the coarse debris within the bag 370 for collecting debris (FIG. 8).

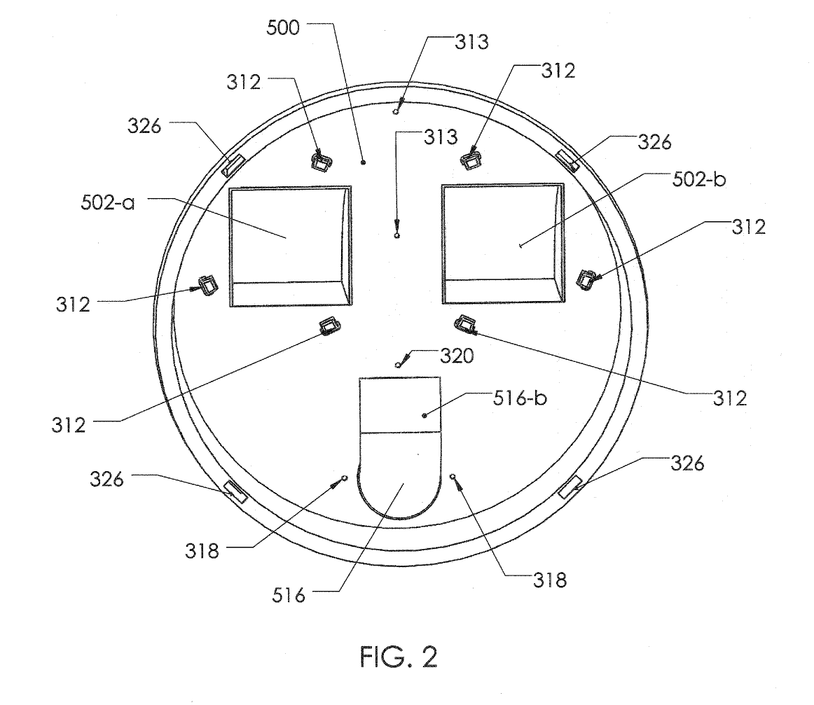

Two holes 313 are located on the central axis YY′ at the junction of the quadrants XY′ and X′Y′. Only one of the two holes is visible in FIG. 1, the two holes are shown in FIG. 2. Both holes 313 are used to make a handle 323 (FIGS. 3 and 8) by inserting a plastic cable tie by the two holes 313 and by linking together the two ends of the cable tie.

Two holes 320 are located on the central axis YY′ at the junction of the quadrants XY and X′Y. The two holes 320 are used to attach a plastic cable tie 336 (FIG. 3) to hold the second end 516-b of the elbow 516 (FIGS. 2 and 3) on the inner face of the lid 500. FIG. 1 shows the end 516-a of the elbow 516, this end will be inserted into the first end of the connecting pipe 311 (FIG. 8). The elbow 516 has an angle between 75 and 100 degrees, the preferred angle being 90 degrees.

The lid 500 has also a third opening 306 near the edge in order to insert the first end of the first connecting pipe 311 (FIG. 8) for the entry of debris through the lid 500. The opening 306 is partially round-shaped with a flared U-shaped extension whose base is directed towards the center of the lid 500. On each side of the opening 306, there are two small holes 318, only one of the two holes is visible in FIG. 1, the two holes are shown in FIGS. 2 and 3. These holes serve as anchor points for attaching a piece of plastic or metal 325 (FIG. 8) to the lid 500. The shape of the flared U-shaped portion of the third opening 306 creates a space for the easy insertion of the first end, which has a slot, of the first connecting pipe 311 (FIG. 8) in the opening 306.

Again on the top of the lid, two inscriptions 315 with the name WilDenLal are printed near the edge of the lid 500 in the central axis XX′ and four small protuberances 309 indicate the position of four elevations 303 on the outer lateral side 321 of the lid 500. It is also understood that the number of small protuberances 309 can be smaller or larger than four.

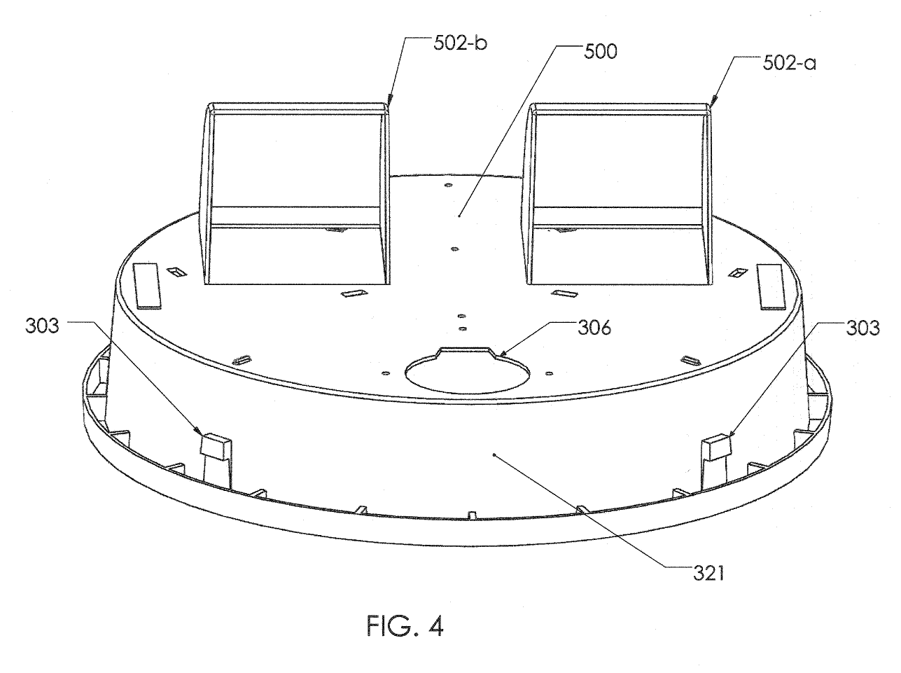

The wall 321 of the lid 500 is slightly inclined outwardly in order to facilitate the movement of debris to the inside of the debris collection bag 370 (FIG. 8). The lid 500 has a curved edge 327 bent in a U-shape consisting of the side wall of the lid and the curve of the extension of the latter bent towards the outside of the lid. Inside the U are lateral reinforcements 331, placed at regular intervals to give more rigidity to the lid 500. The number of reinforcements 331 is twenty, but it may be greater or less according to desired stiffness of the lid 500. On the outer lateral side 321, four elevations 303 are placed at regular intervals. The elevations 303 are rectangular in shape, but they can also be square or round shape. Only two elevations 303 are shown in FIG. 1, the elevations 303 are shown in more detail on FIGS. 4, 5 and 6. It is also understood that the number of elevations 303 can be smaller or larger than four. Without being limiting, the number of elevations 303 can be two, three, four, five or six on the outer lateral side of the lid 500. The elevations 303 are molded with the lid so as to leave sufficient space between the elevations 303 and the curved edge 327 to insert an elastic cord. Without being limiting, it is also understood that the space between the elevations 303 and the curved edge 327 can be between 0.5 cm and 5 cm. The four elevations 303 shown in FIGS. 1, 4, 5 and 6 are disposed at an angle of 45 degrees relative to the central axis YY′. It is also understood that this arrangement is not limiting and that the position of the elevations and the angle can be different relative to the central axis YY′. The elevations 303 are of sufficient height to hold in place an elastic cord 354 (FIG. 8) which will be placed in the space between the curved edge 327 and the elevations 303. The elastic cord 354 has a hook at each end to hold the two ends together when it is stretched and to surround the lateral side 321 of the lid 500. Four sections of anti-skid adhesive tape 310 approximately 2.5 cm wide located immediately after the curved edge 327 are placed on the outside of the lateral side 321 of the lid 500. The sections of anti-skid tape 310 are discontinuous and are placed between the elevations 303. The sections of anti-skid tape 310 allow for an increase in the friction between the wall 321 of lid 500 and the debris collection bag 370 (FIG. 8) to hold it in place around the lid.

FIG. 2 is an underside perspective view of the inside of the lid 500 with the first opening 502-a and the second opening 502-b for the air outlet. The openings 502-a and 502-b are square at their base and are located opposite to the elbow 516. On the edge of the lid 500, one can see four holes 326. These holes are necessary for molding the elevations 303 (FIGS. 1, 4, 5 and 6). Around the first opening 502-a and the second opening 502-b for the air outlet are located three hook-shaped elevations 312 for holding the first strainer 341-a and the second strainer 341-b (FIG. 3). The hook-shaped elevations 312 are arranged around each of the openings 502-a and 502-b so as to form an isosceles triangle in the preferred form, but it is understood that they can also be arranged in different forms. It is also understood that the number of hook-shaped elevations 312 can be higher than three to hold each one of the strainers 341-a and 341-b (FIG. 3). Without being limiting, the number of hook-shaped elevations 312 can also be four to hold each one of the strainers. In FIG. 2 it is also shown the two holes 313 through which will be inserted a plastic cable tie to make the handle 323 (FIGS. 3 and 8). Also shown is one of the two holes 320 through which will be inserted a plastic cable tie to hold the second end 516-b of the elbow 516 in contact with the inner face of the lid 500. Also represented are the two holes 318 through which a plastic cable tie will be inserted to hold the piece 325 (FIG. 8) in plastic or metal on top of the lid 500.

FIG. 3 is an underside perspective view of the inside of the lid 500 with the first strainer 341-a and the second strainer 341-b for filtering the air before it exits through the first opening 502-a and the second opening 502-b. In the edge of the lid 500, one can see four holes 326. These holes are necessary for the molding of the elevations 303 (FIGS. 1, 4, 5 and 6). Around the first strainers 341-a and the second strainers 341-b for the air outlet are located three hook-shaped elevations 312 to hold the first strainer 341-a and the second strainer 341-b. The hook-shaped elevations 312 are arranged in the form of an isosceles triangle in the preferred form, but it is understood that they can also be arranged in different forms. It is also understood that the number of hook-shaped elevations 312 may be smaller or larger than three to hold the first strainer 341-a and second strainer 341-b. In FIG. 3, there is also shown a part of the handle 323, which is made of a plastic cable tie. Also shown is the plastic cable tie 336 to hold the end 516-b of the elbow 516 in contact with the inner face of the lid 500. Also represented are the two holes 318 through which is inserted a plastic cable tie to hold the plastic part 325 (FIG. 8) or in metal on the top of the lid 500.

FIG. 4 is a front perspective view of the top and the outer lateral side 321 of the lid 500 showing in particular the front of the openings 502-a and 502-b with a domed top and back for the air outlet. The openings 502-a and 502-b are square at the base and present on the front of either a square shape or a trapeze shape. When the front shape of the openings is that of a trapeze, the lower base in contact with the lid is greater than the upper base. The front of the openings for the air outlet is oriented towards the axis XX′ (FIG. 1). FIG. 4 also shows the third opening 306 on the top of the lid 500 to allow debris in. The opening 306 is located opposite of the openings 502-a and 502-b. On the outer lateral side 321 of the lid 500, there are shown two elevations 303. The total number of elevations 303 on the lateral side is preferably four, but it can be smaller or larger than four.

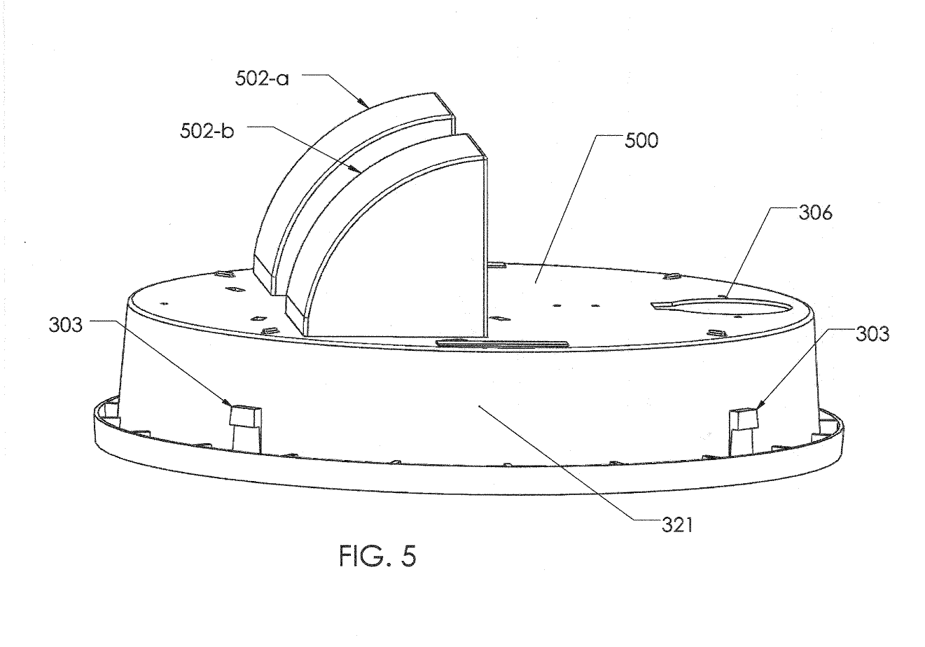

FIG. 5 is a side perspective view of the top and the outer lateral side 321 of the lid 500 showing in particular the openings 502-a and 502-b, of which the base is square and the top and back are domed. The third opening 306 on top of the lid 500 and the two elevations 303 on the outer lateral side 321 are also shown.

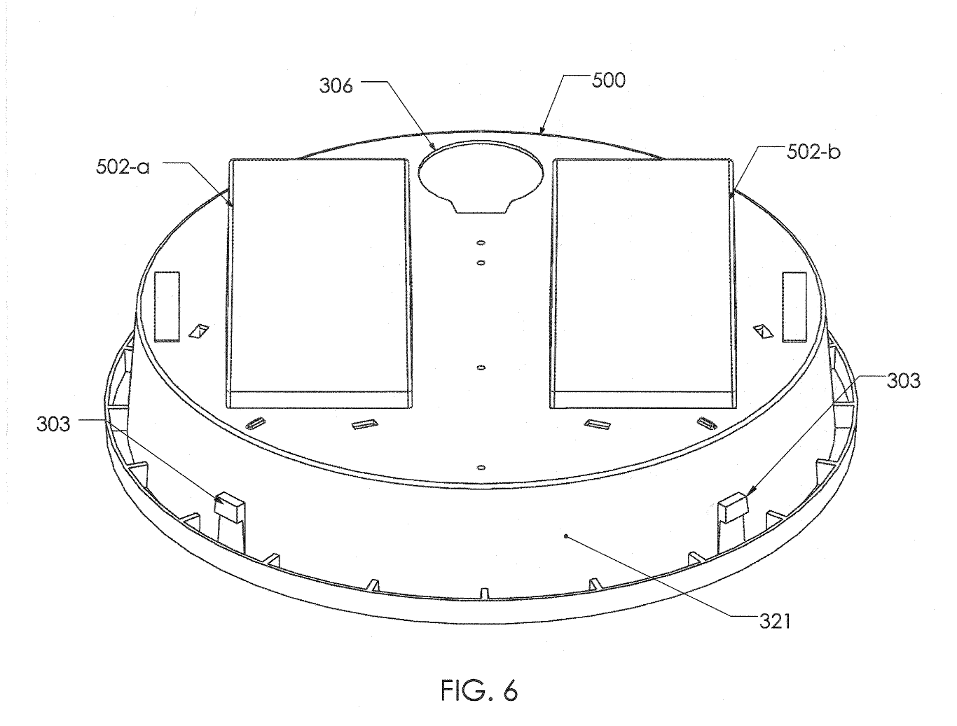

FIG. 6 is a back perspective view of the top and the outer lateral side 321 of the lid 500 with a curved edge and the openings 502-a and 502-b for the air outlet whose base is square and the top and back are domed. The third opening 306 on top of the lid 500 and the two elevations 303 on the outer lateral side 321 are also shown.

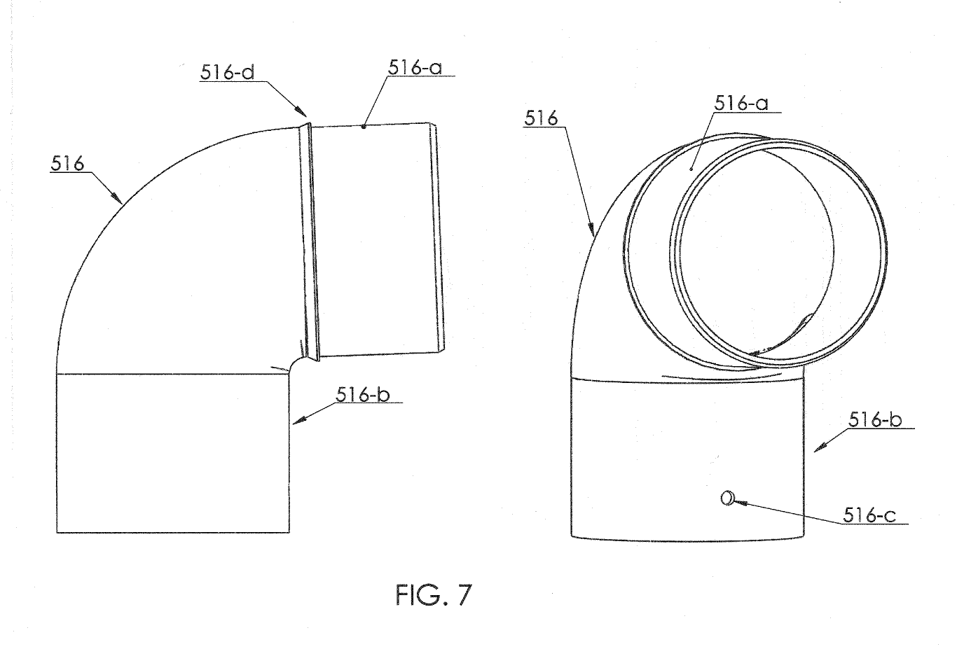

FIG. 7 is a perspective view of the side and the front of the elbow 516, the elbow 516 has an angle between 75 and 100 degrees, the preferred angle being 90 degrees. Both ends 516-a and 516-b of the elbow 516 preferably have the same diameter. It is also understood that the diameter of both ends may be different. The elbow 516 has, in the end 516-b, a hole 516-c to allow insertion of a plastic cable tie and hold the end 516-b in contact with the inside of the lid 500 (FIG. 3). The elbow 516 is shown with an elevation 516 located at the beginning of the end 516-a, the elevation 516-d is to limit the depth of insertion of the end 516-a in the connecting pipe 311 (FIG. 8). It is also understood that the elbow 516 can be made without the elevation 516-d, in that case the end 516-a will be inserted into the connecting pipe 311 up to the curvature of the elbow 516.

FIG. 8 is a perspective view of the lid 500 with a curved edge and the openings 502-a and 502-b for the air outlet when inserted into a debris collection system. The lid 500 has a handle 323 and is inserted into the opening 370 of a debris collection bag. An elastic cord 354 surrounds the membrane 330 and the bag 370 to hold the two in place. The membrane 330 serves to protect the bag 370 from the rough ground while a plastic piece 325 protects the part of the membrane under the lid. The lid 500 is connected to the outlet pipe 308 of a blower/vacuum 307 by a first and a second plastic ribbed connecting pipe 311 and 411, which are held together by the first coupling pipe 402 and by plastic cable ties. The coupling sleeve 410 provides a seal between the outlet pipe 308 and the second connecting pipe 411. The first coupling pipe 402 and the first and the second connecting pipe 311 and 411 are made of a piece of ribbed plastic pipe having the same shape and the same diameter. The wall of the first coupling pipe 402 is slotted over its entire length to allow its insertion above the first and second connecting pipe 311 and 411. A first, a second and a third cable tie 404-a, 404-b and 404-c goes around the first coupling pipe 402 to hold it around the first and second connecting pipe 311 and 411. The first and second connecting pipe 311 and 411 are held together by the sides of the grooves of the first coupling pipe 402. The first coupling pipe 402 allows only lateral rotation of the first and second connecting pipe 311 and 411. A part of the outlet pipe 308 of the blower/vacuum 307 is inserted into the first end of the second connecting pipe 411. The coupling sleeve 410 surrounds the first end of the second connecting pipe 411 which is inserted into the outlet pipe 308. The coupling sleeve 410 is held on the first end of the second connecting pipe 411 by a first, a second and a third cable tie 406-a, 406-b and 406-c. These cable ties are placed around the coupling sleeve 410 and the first end of the second connecting pipe 411 in three grooves. A first and a second lateral cable tie 412-a and 412-b are placed perpendicular to the cable ties 406-a, 406-b and 406-c. The first lateral cable tie 412 is held in place by a first cable tie 406, while the second lateral cable tie 412-b is held in place by the second cable tie 406-b. To hold the outlet pipe 308 in the first end of the second connecting pipe 411, a fourth cable tie 408 surrounds the outlet pipe 308 and a part of the coupling sleeve 410, while at the same time passing through the two loops formed by the two lateral cable ties 412-a and 412-b. All cable ties are made of plastic and can be reusable or non-reusable.

### Operation of the Debris Collection System

To use the lid for collecting debris of the present invention, the operator must first install the various components on the lid 500. The operator must first place on the wall 321 of the lid, at the bottom of the curved edge 327, the sections of the self-adhesive anti-skid tape 310. Thereafter, on the underside of the lid 500, the operator inserts the first and the second strainers 341-a and 341-b between the hooks 312.

Then the operator makes the handle 323 by introducing a plastic cable tie in both holes 313 and closes it onto the inside of the lid 500.

In the next step, the operator inserts the first end of the first connecting pipe 311 into the opening of the plastic or metal part 325, and then, into the front opening of the membrane 330.

Thereafter, the operator introduces into the opening 306, by the outer face of the lid, the first end of the first connecting pipe 311. Then, by the inside of the lid 500, it introduces the first end 516-a of the elbow 516 into the opening of the first end of the first connecting pipe 311, and then attaches the second end 516-b of the elbow 516 with the cable tie 336. The second end 516-b of the elbow 516 is then directed between the first and the second strainers 341-a and 341-b, this ensures directional stability of the elbow 516 to the entrance of debris and air. The plastic or metal part 325 and the membrane 330 are then attached to the lid 500 by the holes 318. Then the operator places the cable tie 335 around the first end of the first connecting pipe 311 where the first end 516-a of the elbow 516 is inserted into the first connecting pipe 311. The cable tie 335 is placed in a groove of the ribbed connecting pipe 311.

The next step consists in the insertion of the second end of the first connecting pipe 311 and the second end of the second connecting pipe 411 into the first coupling pipe 402. The operator then places the first, the second and the third cable tie 404-a, 404-b and 404-c into three grooves of the first coupling pipe 402.

Thereafter, he inserts the first end of the second connecting pipe 411 into the coupling sleeve 410 and places without tightening too much the first, the second and the third cable tie 406-a, 406-b and 406-c around the coupling sleeve and the second connecting pipe 411. He introduces the first and second lateral cable tie 412-a and 412-b between the coupling sleeve and the cable ties 406-a and 406-b respectively and firmly clamps the cable ties 406-a, 406-b and 406-c.

The operator inserts the outlet pipe 308 of the blower/vacuum 307 into the first end of the second connecting pipe 411 up to the elevation on the outlet pipe 308. It places the fourth cable tie 408 around the outlet pipe 308 behind the elevation so as to go around a part of the lateral cable ties 412-a and 412-b at the same time. Cable ties 412-a and 412-b are then closed in on themselves by joining the two ends and adjusted to hold the outlet pipe 308 of the blower/vacuum 307 into the first end of the second connecting pipe 411.

The final steps are to insert the part of the lid 500 into the opening of the bag 370 to collect the debris and then to put the elastic cord 354 over the membrane 330 and the bag 370 between curved edge 327 and the elevations 303 of the lid 500. Two hooks of the elastic cord 354 are used to connect the two ends and to keep tension on the walls of the membrane 330 and the bag 370. In this position, the top of the lid 500 is perpendicular to the walls of the membrane 330 and the bag 370.

Next, the operator activates the blower/vacuum 307 and proceeds with the vacuuming up of leaves or twigs. The leaves and the air sucked up are thrown out by the fan outlet pipe 308 of the blower/vacuum 307 into the second and the first connecting pipe 411 and 311 and then into the lid 500 between the two strainers 341-a and 341-b, up to the wall of the lid. From there, the debris is deflected laterally towards the bottom of the bag 370 for collection of the debris while the air flow brought in passes through the strainers 341-a and 341-b and goes out by the openings 502-a and 502-b. The fast air flow between the two strainers 341-a and 341-b has the effect of preventing debris from adhering sufficiently to the domed surface of the strainers to negatively affect the air outlet. When the bag 370 begins to fill up, the operator stops the blower/vacuum 307, lifts the lid 500 by using the handle 323 and compresses the debris by pressing the side of the bag 370 in order to put in more debris. The operator restarts the blower/vacuum 307 and continues to collect leaves.

The operator can move around the field by sliding the bag on the ground without having to carry the weight of the debris. The membrane 330 and the part of thick plastic or metal 325 under the bag protect and facilitate the sliding of the bag 370 on the ground. The coupling pipe 402 and the first and the second connecting pipe 311 and 411 facilitate the mobility of the blower/vacuum in several directions without having to always move the bag 370. When the bag 370 is full, the operator stops the blower/vacuum 307, loosens the elastic cord 354 around the lid 500 to remove the tension on the bag 370, frees the bag 370 from the lid 500 and slightly compresses the top of the bag 370 in order to have enough space to close the opening of the bag 370 with a tie or a knot. The debris remains in the collection bag 370 without having to pour it into another bag. The operator places a new bag 370 on the side wall of the lid, installs the elastic cord 354, restarts the blower/vacuum 307 and can proceed rapidly to the work of collecting leaves and other lawn debris.

All kinds of bags can be used, provided they are large enough to insert the lid 500 in the opening of the bag 370. The type of bag can be sealed or not, plastic, paper or other material.

We claim:

1. A lid for leaf collection with a blower/vacuum and the discharge of debris into a bag, the lid is round-shaped with a flat or domed top and has a lateral side with a curved 360-degree U-shaped edge which comprises: two openings with a square base and with a domed top and back for air outlet; b) a partially round opening with a flared U-shape for the entry of debris; an elbow for the entry of debris; holes to hold the elbow to the lid; two strainers for air filtration and retention of debris; d) hooks to hold the two strainers for air filtration and retention of debris and; e) holes in the lid to make a handle; and elevations on the lateral side of the lid.

2. The lid of claim 1 wherein the curved 360 degree U-shape edge is made by the lateral side of the lid and the curvature of the extension of the wall folded towards the outside of the lid.

3. The lid of claim 2 wherein the curved U-shaped edge has inside, at regular intervals, side reinforcements to give more rigidity to the lid.

4. The lid of claim 1 wherein the lateral side is slightly flared towards the outside of the lid relative to the top of the lid.

5. The lid of claim 1 wherein the two openings for air outlet are respectively in a quadrant XY′ and in a quadrant X′Y′, which are delimited by a central axis YY′ passing through the center of the lid and the center of the opening to allow debris in and a central axis XX′ passing through the center of the lid, the central axis XX′ being perpendicular to the central axis YY′.

6. The lid of claim 5 wherein the two openings for air outlet both have a front which is oriented towards the axis XX′.

7. The lid of claim 6 wherein the two openings for air outlet both have a square-shaped or trapeze-shaped front with a lower base and an upper base and of which the lower base of the trapeze is larger than the upper base.

8. The lid of claim 1 wherein the elbow has an angle between 75 and 100 degrees and of which the elbow is inserted into the opening to allow debris in, on either side of the lid.

9. The lid of claim 8 wherein the elbow has two ends with the same diameter.

10. The lid of claim 1 wherein the elbow is inclined towards the inner face of the lid.

11. The lid of claim 1 wherein the hooks are three or four in number for each strainer and wherein the end of the hook rests on the rigid edge of the strainer which is not in contact with the lid.

12. The lid of claim 1 wherein the elevations are two or three or four or five or six in number, which are molded directly with the lid on the lateral side of the lid so as to retain an elastic cord.

13. The lid of claim 12 wherein the elevations are placed close to the curved edge of the lid.

14. The lid of claim 1 wherein sections of rough anti-skid tape are two or three or four or five or six in number, which are glued on the lateral side of the lid at the lower end of the 360 degree curved edge and between the elevations on the lateral side of the lid.

15. The lid of claim 1 wherein two holes are placed on each side of the opening to allow debris in on an axis which passes through the center of the round part of the opening to allow debris in and which is parallel to a central axis XX′ passing through the center of the lid and which is perpendicular to a central axis YY′ passing through the center of the lid and the center of the opening to allow debris in.
